(19) United States
(12) Patent Application Publication
(10) Pub. No.: US 2003/0046678 A1
(43) Pub. Date: Mar. 6, 2003

(54) Computer hardware and software installation apparatus and method

(76) Inventors: Robert Boxall, Chicago, IL (US); Dragan Pleskonjic, Belgrade (YU); Sasa Tomasevic, Belgrade (YU)

Correspondence Address: SKJERVEN MORRILL LLP, THREE EMBARCADERO CENTER, 28TH FLOOR, SAN FRANCISCO, CA, 94111, US

(21) Appl. No.: 09/945,547

(22) Filed: Aug. 30, 2001

(51) Int. Cl. G06F 9/445

(52) U.S. Cl. 717/174

(57) ABSTRACT

A method of installing hardware and corresponding software comprising the steps of initiating the installation process for a hardware element having corresponding software, monitoring the operating system for commands which require user intervention, analyzing the commands received from the operating system, and responding to the commands received from the operating system without requiring user intervention. The invention further comprises an installation script for use in association with a computer and an associated hardware element or software element. The script comprising a monitoring mechanism, an analyzing mechanism and a responding mechanism. The monitoring mechanism monitoring a request for user intervention by an operating system. The analyzing mechanism analyzing the request to determine a response thereto. The responding mechanism responding to the request without substantially requiring user intervention.

### BACKGROUND OF THE INVENTION

1. Field of the Invention

The invention relates in general to computer hardware and software, and, more particularly, to a computer software to facilitate installation of computer hardware and software onto a computer, such as, for example, the installation of a wireless LAN (WLAN) PCMCIA card onto a personal computer. The system is not limited to any particular hardware or to any particular operating system.

2. Background Art

The use of personal computers is ever increasing. With the world wide web and with email, the need for personal computers in daily life has forced even novice computer users to become more technology driven. One area that has plagued many computer users is the installation of hardware and software. With respect to hardware, while operating systems have made great strides toward “plug and play” architecture, typical hardware installations nevertheless require user intervention and, many times, a knowledgeable user.

As an example, the use of wireless networks has become increasingly popular. In fact, hotels are beginning to provide their users with wireless cards (hardware with which to access the hotel network, their email and the world wide web). One problem that has occurred is that many computer users are fearful of the installation of the hardware necessary to access the hotel network. In turn, these users do not take advantage of the services offered by the hotel.

It is therefore an object of the present invention to provide a system to facilitate the installation of hardware onto a computer.

It is another object of the invention to provide a system to facilitate the installation of software onto a computer.

It is yet another object of the invention to provide a system which installs various hardware such as WLAN cards Video Cards, Ethernet Cards, Memory Sticks, etc. and associated software onto a computer system without substantial user knowledge or intervention.

These and other objectives will become apparent in light of the specification appended hereto.

### SUMMARY OF THE INVENTION

The invention comprises a method of installing hardware and corresponding software comprising the steps of initiating the installation process for a hardware element having corresponding software, monitoring the operating system for commands which require user intervention, analyzing the commands received from the operating system and responding to the commands received from the operating system without requiring user intervention.

In one embodiment, the hardware comprises a wireless LAN card. In another embodiment, the steps of analyzing and responding is repeated each time the operating system requires user intervention. Preferably, the step of analyzing and responding is repeated at least three times.

The invention also comprises an installation script for use in association with a computer and an associated hardware element or software element. The script comprises means for monitoring a request for user intervention by an operating system, means for analyzing the request to determine a response thereto and means for responding to the request without substantially requiring user intervention.

In one embodiment, the analyzing means and the responding means are capable of responding to a plurality of different requests.

In another embodiment, the hardware comprises a wireless LAN card. In yet another embodiment, the operating system comprises one of the group consisting of: Windows 95, 98, Me, NT, 2000, XP, MacOS, Linux and PalmOS.

Preferably, the installation script comprises software stored on a removable media such as a CD.

In another aspect of the invention, the invention comprises a method of installing hardware comprising connecting the hardware to a computing device, providing a storage media having an installation script, initiating the installation script, monitoring the operating system for commands which require user intervention, analyzing the commands received from the operating system, responding to the commands received from the operating system without requiring user intervention, and, repeating the steps of analyzing and responding until the hardware is installed.

In one embodiment, the step of repeating occurs at least five times.

### BRIEF DESCRIPTION OF THE DRAWINGS

FIG. 1 of the drawings is a schematic view of a computer using the system of the present invention; and

FIG. 2 of the drawings is a sample dialogue window which may be generated by an operating system, such as a windows operating system.

### BEST MODE FOR PRACTICING THE INVENTION

While this invention is susceptible of embodiment in many different forms, there is shown in the drawings and will be described in detail, one specific embodiment with the understanding that the present disclosure is to be considered as an exemplification of the principles of the invention and is not intended to limit the invention to the embodiment illustrated.

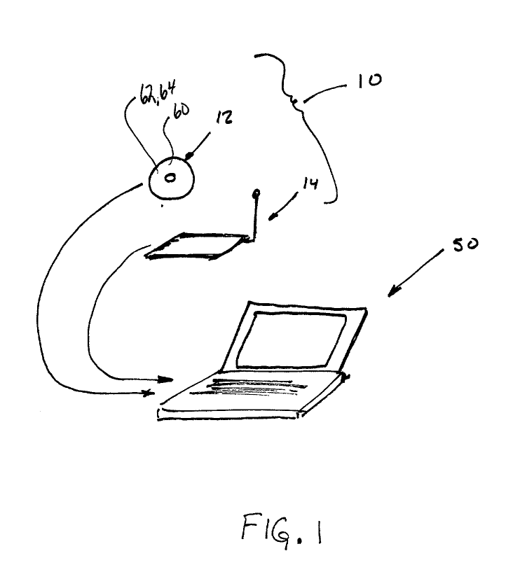

Referring now to the figures, and in particular to FIG. 1, system is shown generally as 10. System 10 is generally used in association with computer 50. Computer 50 may comprise a personal computer, such as a laptop computer operating under any one of a number of operating systems (i.e. Windows 95, 98, Me, NT, 2000, XP, MacOS, Linux, among others). In addition, computer 50 may comprise other systems, such as PDA's operating under various operating systems (PalmOS, Windows CE, Pocket PC, etc.). Indeed, the system is not limited to any particular type of computer running any particular type of operating system.

System 10 comprises storage media 12 and hardware 14. Storage media 12 includes the software 60 necessary to install and configure hardware 14. While storage media 12 is shown as comprising a CD, other types of media such as a floppy disk, flash memory (i.e., SM, MMC, CF, etc.) or other type of media. Indeed, the application is not limited to any particular type of media.

Hardware 14 may comprise any number of hardware components, such as a modem, a wired NIC card, a wireless NIC card, a disk drive controller. The system will be described with reference to a wireless NIC card, with the understanding that it is equally applicable for adoption and use in association with other hardware components.

Software 60 includes installation components 62 and installation script 64. Installation components 62 includes the conventional drivers and software necessary to provide computer 50 with the necessary information to communicate with and to operate hardware 14. Installation script 64 comprises a software code which facilitates the operation of the installation components without substantial intervention by the user.

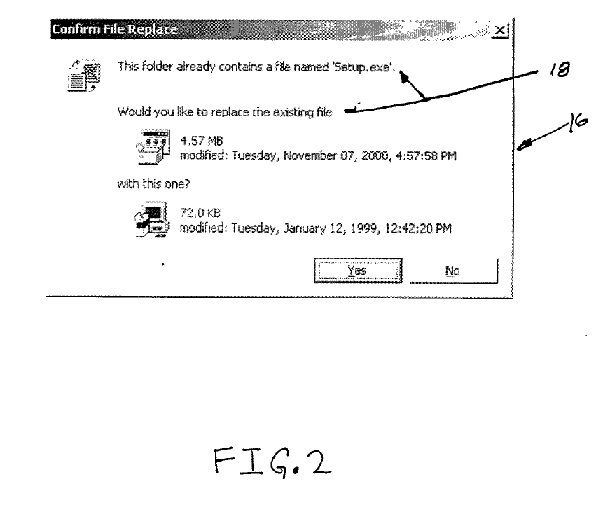

To accomplish the installation without substantial intervention by the user, installation script 64 includes means for monitoring the system for user intervention prompts, means for analyzing any detected user intervention prompts and means for responding to the user intervention prompt. In, for example, a Windows environment, the monitoring means monitors the appearance of a windows dialogue screen 16 (a sample of which is shown in FIG. 2). If such a screen is detected, the analyzing means determines the text that has appeared in the dialogue screen and compares the data to a software table which includes various text output 18 (FIG. 2) which may appear in a dialogue box with corresponding actions. The responding means is then directed to execute the corresponding action in response to the text received in the dialogue box. For example, the installation script may be written in a scripting language which allows for the use of If statements, such as “IF “text” then execute action “x”, wherein the “text” corresponds to text received within a dialogue box and “x” is a command which is to be executed by the operating system. The proper actions and responses can be determined by a repeated manual installation on various machines. Such a script can be written by one of skill in the art having the present disclosure before them.

The operation of the system will be described with reference to the installation of a WLAN PCMCIA card into a laptop computer operating in a Windows environment, to, for example, gain access to a computer network in a hotel. The user first obtains the required hardware (WLAN PCMCIA card) from the hotel, such as, at the time of check in. The user is likewise provided with a software media, such as a CD which includes the necessary software. The user places the CD in the CD drive of the laptop computer and the hardware in the PCMCIA slot. The CD is either prompted to begin, or begins automatically, and brings up a dialogue box which prompts the user to click “yes” or a radio button or to otherwise prompt a system to begin the installation process (different operating systems will require different steps for the initiation of the software install procedure, some will require the user only to insert the components, whereas others will require the user to click OK in a dialogue box, etc.). The user affirmatively responds and the installation process is initiated. The installation process begins the installation script which monitors the system. Next, the necessary software components (conventionally provided software) is loaded onto the system.

As is common with the installation of hardware and software components, the installation procedure generates a situation which generally requires user intervention. In general, when such a situation is reached, the operating system (in this example, Microsoft Windows) generates a dialogue box 16 (FIG. 2) which includes text 18 and generally user actionable buttons, or textual areas. Whereas, in a conventional system, user intervention would be required to resolve the dialogue box to continue, the system of the present invention requires no such intervention. Instead, the monitoring means of the installation script monitors such dialogue boxes. When such a dialogue box is generated by the operating system, the monitoring means directs the analyzing means to analyze the text in the dialogue box. The script includes a table of information that links corrective action with possible text that may appear in a dialogue box. The script then executes the corrective action as a response without requiring user intervention.

For example, a typical dialogue box that may appear during installation is one that indicates to the operator that the installation procedure is attempting to install a software component onto the system to replace an apparently newer version of the same software component already on the system. Such a dialogue box from a Windows operating system is shown in FIG. 2. In such a situation, the analyzing means determines the above situation based upon the text generated within the dialogue box, namely text 18 such as “would you like to replace the existing file” or “this folder already contains a file named ‘setup.exe’”. The analyzing means includes a corresponding response to a dialogue box containing such text. The corresponding response may be to click the “No” button so that the newer file remains in the system. As such, the responding means is directed to provide the operating system with the equivalent to the “No” response. The installation will then proceed as if the user responded “No” to the dialogue box.

Another typical dialogue box is one that requests a file which cannot be found in the conventional location. In such a situation, the user is generally required to provide the location of the particular file, and, then manually click the OK or proceed radio button in the dialogue box. With the present system, the system can scan not only the common locations for the different files, but the entire drive or drives for the particular file. Once all locations are searched, the system can automatically enter the location of the file (even if it is not the general location of the file), and, then automatically cause the OK or proceed radio button in the dialogue box.

This process will continue until the installation is completed, or until a dialogue box is presented that has text which does not correspond to any text contained in the table of the analyzing means. In such a situation, user intervention is generally required. As the system is propagated and the installation procedure is completed on various machines, it is believed that the table can be written that corresponds to virtually all of the dialogue boxes that may appear during an installation. As such, virtually all installation procedures will require virtually no intervention by the user. In turn, the user will be capable of installing hardware (and corresponding software) without any special skills. Of course, as a new, unfamiliar dialogue box is received (i.e. a dialogue box not identified or not appearing in previous installations or in test installations), the programmers of the configuration script of the software can update same with instructions to the responding means which corresponds to the newly uncovered dialogue box text. In certain embodiments, the system can automatically trigger a message to a centralized location (i.e., the vendors support email) so that a record is created corresponding to the newly identified dialogue box. In such an embodiment, the script can be updated. In addition, prior to installation, the system can be prompted by the user or automatically to contact the vendor to download the newest driver (if connectivity is available).

It will be understood that this system can be configured for use in association with the installation of various software and hardware components for various types of computer systems operating various operating systems. The system is well suited for use in association with computer systems in situations wherein the user is of limited experience with installation procedures.

For example, in another embodiment, the system may be incorporated into a drive upgrade routine. Specifically, when a user downloads a replacement (i.e., updated) driver for hardware or software, the updated driver can include the above-identified system. In such an embodiment, the user merely activates the driver, and the driver install procedure automatically loads the driver (providing automatic responses to the dialogue boxes) without requiring intervention by a user.

The foregoing description merely explains and illustrates the invention and the invention is not limited thereto except insofar as the appended claims are so limited, as those skilled in the art who have the disclosure before them will be able to make modifications without departing from the scope of the invention.

What is claimed is:

1. A method of installing hardware and corresponding software comprising the steps of:
initiating the installation process for a hardware element having corresponding software;
monitoring the operating system for commands which require user intervention;
analyzing the commands received from the operating system; and
responding to the commands received from the operating system without requiring user intervention.

2. The method of claim 1 wherein the hardware comprises a wireless LAN card.

3. The method of claim 1 wherein the steps of analyzing and responding is repeated each time the operating system requires user intervention.

4. The method of claim 1 wherein the step of analyzing and responding is repeated at least three times.

5. An installation script for use in association with a computer and an associated hardware element or software element, the script comprising:
means for monitoring a request for user intervention by an operating system;
means for analyzing the request to determine a response thereto;
means for responding to the request without substantially requiring user intervention.

6. The installation script of claim 5 wherein the analyzing means and the responding means are capable of responding to a plurality of different requests.

7. The installation script of claim 5 wherein the hardware comprises a wireless LAN card.

8. The installation script of claim 5 wherein the operating system comprises one of the group consisting of: Windows 95, 98, Me, NT, 2000, XP, MacOS, Linux and PalmOS.

9. The installation script of claim 5 wherein the installation script comprises software stored on a removable media.

10. The installation script of claim 9 wherein the removable media comprises a CD.

11. A method of installing hardware comprising:
connecting the hardware to a computing device;
providing a storage media having an installation script;
initiating the installation script
monitoring the operating system for commands which require user intervention;
analyzing the commands received from the operating system;
responding to the commands received from the operating system without requiring user intervention; and
repeating the steps of analyzing and responding until the hardware is installed.

12. The method of claim 11 wherein the step of repeating occurs at least five times.
